(19) United States
(12) Patent Application Publication
(10) Pub. No.: US 2007/0143795 A1
(43) Pub. Date: Jun. 21, 2007

(54) Application trace for distributed systems environment

(76) Inventor: Duong-Han Tran, Bad Schoenbom (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/313,974

(22) Filed: Dec. 20, 2005

(51) Int. Cl. H04N 5/445; H04N 7/10; H04H 9/00; H04N 7/16; G06F 3/00; G06F 13/00; H04N 7/025

(52) U.S. Cl. 725/46; 725/13; 725/35; 725/9

(57) ABSTRACT

Methods and systems are provided for making application trace data for a local system available to others within an enterprise services network. A user at system remote to the server can specify trace data collection preferences and trace data is collected based on the user preferences. The trace data is stored in a database at the server in a standard format for web browsers and accessible to users of both SAP and non-SAP systems.

### FIELD OF THE INVENTION

The present invention relates to methods and systems for providing an application programming interface (API) for functional trace data and, more particularly, methods and systems for making application trace data for a local system available to others within an enterprise services network.

### BACKGROUND OF THE INVENTION

An enterprise services network is an open architecture network incorporating services oriented architecture principles and web services technologies applied to enterprise business applications. Web services, and enterprise services networks, employ open standards, such as Extensible Markup Language (XML), Web Services Description Language (WSDL), HypterText Transfer Protocol (HTTP), Secure HypterText Transfer Protocol (S-HTTP or HTTPS), Simple Object Access Protocol (SOAP), Universal Description, Discovery and Integration (UDDI), Business Process Modeling Language (BPML), Business Process Execution Language (BPEL), and others, to allow for system integration independent of technical architecture and interoperability between even disparate platforms. Enterprise services allow IT organizations to develop applications, that is, applications that combine functionality and information from various, existing, application systems to support new business processes or scenarios. Web services that provide the functionality of one application system are also called “application services.”

Many enterprise services networks are heterogeneous, that is, they comprise several different customer and vendor platforms. For example, an enterprise services network may include SAP systems, such as SAP's NetWeaver™, SAP's development and integration platform running Advanced Business Application Programming (ABAP), SAP's application programming language, or an Internet Transaction Server (ITS), and non-SAP systems, such as a platform running Java 2 Platform Enterprise Edition™ (J2EE), such as IBM's WebSphere. An ITS is an interface that enables efficient communication between an SAP R/3 system of applications and the Internet, enabling user access to Internet application components, which are Web-enabled business applications for the R/3 system. J2EE is the standard platform, developed collaboratively by Sun Microsystems and other software vendors, for developing multi-tier enterprise applications based on the Java programming language.

On heterogeneous networks, it can be difficult to debug errors that occur during running of an application, particularly an application on a non-SAP system. One way to debug an application is to use a trace function. Trace functions record and log information about the operation of the applications and the systems they run on. However, conventional trace functions available to developers in a heterogeneous enterprise services architecture have limitations. For example, a developer working on an SAP platform can display raw statistical data (individual records) and traces from ABAP and non-ABAP systems in a heterogeneous architecture using the ABAP functional trace, STATTRACE. The statistics and trace data of remote ABAP systems is accessed by Remote Function Call (RFC). For remote non-ABAP systems in the architecture, such as a J2EE or ITS server, the data is read using a monitoring agent, such as a CCMS agent. CCMS agents are independent processes with an interface through RFC to a central monitoring system and an interface to a shared memory. This functional trace, however, can only be activated by a user at an SAP system. Within an SAP system running ABAP, this functional trace is system-specific and can only be activated by an ABAP transaction. Moreover, the application cannot record changes of application data during the processing. In addition, the recorded functional trace data can only be accessed by the SAP system and not by any other non-SAP system.

Specialized trace functions for particular applications, like SAP's Customer Relationship Management and Business Warehouse applications, have been developed for used in SAP systems running ABAP. These specialized trace functions, however, are not unique and store data at the SAP system that is not accessible from outside the SAP system, such as by developers physically located outside the SAP system.

In short, there exists a need for methods and systems for tracing ABAP applications without the need to develop specialized trace functions. There is also a need to be able to access the trace data at remote systems and from non-SAP systems.

### SUMMARY OF THE INVENTION

In accordance with some embodiments consistent with the present invention, a method for collecting application trace data in a computer system comprising at least a server and a remote computer system comprises activating a trace function at the server in response to a request from a first remote computer system; receiving information representing user preferences for collecting trace data for debugging an application communicating between the server and a second remote computer system; collecting, with the trace function, trace data related to execution of the application based on the user preference information; and storing the collected trace data at the server in a standard format for web browsers.

It is to be understood that both the foregoing general description and the following detailed description are exemplary and explanatory only and are not restrictive of the invention, as claimed. These and other embodiments are further discussed below with respect to the following figures.

### BRIEF DESCRIPTION OF THE DRAWINGS

FIG. 1 is a block diagram of an exemplary system for using an application trace function module consistent with the present invention.

FIG. 2 is a flow chart illustrating a method for providing trace data according to some embodiments of the present invention.

### DESCRIPTION OF THE EMBODIMENTS

Reference will now be made in detail to the exemplary embodiments of the invention, the examples of which are illustrated in the accompanying drawings. Wherever possible, the same reference numbers will be used throughout the drawings to refer to the same or like parts.

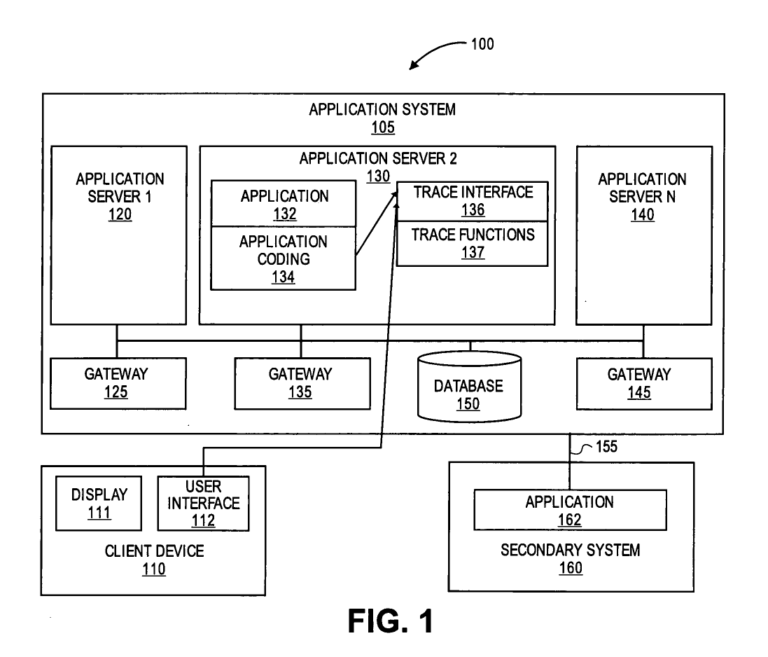

FIG. 1 is a block diagram of an exemplary system 100 for using an application trace function module consistent with the present invention. As shown in FIG. 1, system 100 comprises an application system 105, at least one client system 160 and, optionally, client system 110.

As shown in FIG. 1, application system 105 may include a database 150 and one or more application servers (120, 130, 140). In some exemplary embodiments, application system 105 may be a platform running SAP's NetWeaver, SAP's suite of development and integration components. One of the components of SAP's NetWeaver is SAP Web Application Server (SAP Web AS), which supports both ABAP code and Java code that meets the J2EE specifications.

Application system 105, and each of application servers 120, 130, 140, can communicate with client system 110 via user interface 112. User interface 112 may be, for example, the SAP Graphical User Interface (SAP GUI) protocol. In some embodiments, application system 105 communicates with client system 160 via gateway 125, 135 or 145. Gateways 125, 135, and 145, for example, provide a standardized interface for system-wide communication between systems. Gateways 125, 135, and 145 can connect dissimilar networks by converting different protocols, transfer speeds, and different codes. Each of gateways 125, 135, and 145 can act as an entrance to the application system 105 by connecting the client system 160 to the application system 105. As shown in FIG. 1, each application server 120, 130, 140 of application system 105 has its own gateway. External applications may register at any of gateways 125, 135, and 145 to enable communication with one or more of application servers 120, 130, 140.

The gateways communicate with client system 160 using conventional network connections 155. Conventional network connections 155 may include, alone or in any suitable combination, a telephony-based network, a local area network (LAN), a wide area network (WAN), a dedicated intranet, wireless LAN, the Internet, a wireless network, a bus, or any other communication mechanism. Further, any suitable combination of wired and/or wireless components and systems may be used to provide network connections 155. Moreover, network connections 155 may be embodied using bi-directional or unidirectional communication links. Further, network connections 155 may implement protocols, such as Remote Function Call (RFC), the SAP ABAP programming language implementation similar to the Remote Procedure Call (RPC) protocol, Transmission Control Protocol/Internet Protocol (TCP/IP), HTTP, SOAP, and the like.

As shown in FIG. 1, application server 130 includes an application 132 and an application coding 134. Although shown only with respect to application server 130, each of application servers 120, 140 may likewise include an application and application coding. Application 132 may be any enterprise application such as, for example, SAP's Customer Relationship Management (CRM) or Supply Chain Management (SCM) products. Application 132 may also be a composite application, such as any of the components of SAP's xApps family, or may be a custom application. Application coding 134 translates messages and data into the appropriate format for transmission to other application servers or, for example, to client system 160 over gateway 135.

Application coding 134 translates messages and data into the appropriate format for transmission to client system 160 over gateway 135. For example, application coding 134 may translate messages generated by application 132 into message formats used by the network protocols mentioned above, that is, TCP/IP, HTTP, SOAP, RFC, and the like. Application coding 134 may also translate data generated by application 132 into standard data formats such as XML, Web Services Description Language (WSDL) and the like.

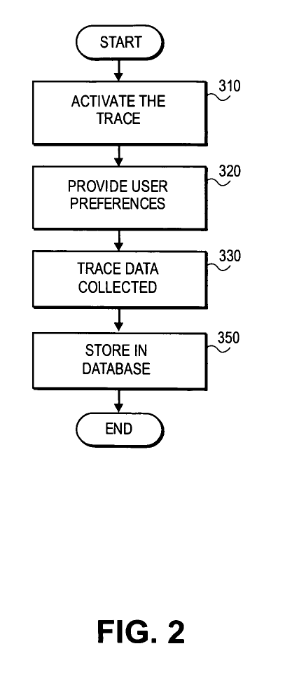

Consistent with the present invention, application server 130 also includes trace interface 136 and trace function 137. The trace function 137 may use the same database 150 as application system 105 and application servers 120, 130, 140 but it uses a second database connection to immediately insert and commit the trace data into the database. Trace function 137 is a suite of functions for collecting trace data in connection with the operation of application 132. Trace function 137 may use the same database 150 as application system 105 and application servers 120, 130, 140 and may also use a second database to immediately insert and commit trace data. Trace interface 136 is a user interface for receiving input from a user indicating preferences for the collection of trace data, as is consistent with the present invention, and as will be explained in more detail with reference to FIG. 2 below.

Client system 110 can be a conventional personal computer (PC) including, for example, a processor, a random access memory (RAM), a program memory (for example, read-only memory (ROM), a flash ROM), a hard drive controller, a video controller, and an input/output (I/O) controller coupled by a processor (CPU) bus. In certain embodiments, client system 110 includes a display 111 and one or more user input devices that are coupled to client system 110 via an I/O bus. Alternatively, separate connections (separate buses) can be used for the I/O interface, display, and the user input devices.

Client system 110 provides a user interface 112 that allows a user to display and manipulate data stored in database 150. The user interface 112 can be, for example, a web-based interface having a web browser or can be a non-web interface, such as SAP Graphical User Interface (SAP GUI) capable of displaying trace data stored in eXtensisble Markup Language (XML) format or other standard format for data.

Client system 160 may be, for example, an ABAP server, a J2EE server, an Internet Transaction Server (ITS), or an SAP-Business Connector (SAP-BC) system. Client system 160 includes at least a processor, a random access memory (RAM), and a program memory (for example, read-only memory (ROM), a flash ROM), and is operatively connected to a display and at least one input device.

In some embodiments, application 162 on client system 160 communicates with the application 132 via application coding 134 and it can require application coding 134 to call different trace function 137 via trace interface 136. Application 162 on client system 160 and application 132 on application system 105 are applications that can be analyzed and debugged.

Application 162 on client system 160 communicates with application 132 using a database 150 located at application system 105. In at least some embodiments, database 150 stores trace data in XML format.

FIG. 2 is a flow chart illustrating a method for providing trace data according to some embodiments of the present invention. As shown in FIG. 2, a user at client system 160 activates application trace interface 136 (stage 310). In some embodiments the user may active the application trace interface 136 from client system 110.

After activating application trace interface 136, the user may provide one or more user preferences for collecting trace data (stage 320). A user may provide preferences by, for example, inputting the user preferences into application trace interface 136. The user may, for example, indicate the type of trace data that should be collected. Trace data can include, among other things, SQL enqueue data, remote function call, and the like. The user may also indicate, for example, display and analysis options. In certain embodiments, the user may indicate other preferences such as a start time, end time, length of collection period, initial system, initial user, initial action and transaction ID.

In certain embodiments, the user may indicate the particular components of the system that the user wishes to monitor. For example, in certain embodiments, the user may wish to monitor all systems assigned to a particular business process. In certain other embodiments, a user may wish to collect trace data for all local components within a system, such as a local ABAP system. In another example, the user may wish to only collect trace data for all calls from and to an application.

After the user preferences have been provided, the trace data is collected (stage 330). Application coding 134 calls the trace function 137 by using trace interface 136 and passing information about the call (i.e. name of the component, name of the call/operation) and data to be traced.

Each entry of trace data contains time data, such as the current local time. In certain embodiments, the present invention can be used not only for checking data from and to a currently running application but also for getting the duration of calls to other applications located on the same or remote system. This can be done, for example, by calling a trace function consistent with the present invention directly before and after calling another local or remote application. The trace data is then stored in database 150 (stage 350).

Based on the user preferences indicated, application trace interface 136 generates one or more function modules that can be called to write trace data to the database. For example, the interface may include a first trace write function module, such as SCOL_TRACE_WRITE, that writes the trace data directly to a database. The trace function uses a second database connection to immediately insert and commit the trace data into database. The first trace write module passes an input parameter that indicates where the trace data should be written based on the user-indicated preferences. Optionally, the interface may include a second trace write function module, such as SCOL_TRACE_WRITE_BUFFER_TO_DB, a function module that writes the buffered trace data to the database.

In embodiments consistent with the present invention, the trace write function module converts the trace data into XML format before writing the trace data into the database. In preferred embodiments, the trace data in XML format is stored on database 150 on application system 105, shown in FIG. 1.

Storing the trace data in XML format provides accessibility to the data to both internal and external users, as the data can then be accessed by both ABAP and non-ABAP systems. For example, trace data collected and stored in database 150 may be accessed by either client system 110 or client system 160. A user at any of these devices may, for example, download the trace data and display the trace data using a web browser, such as Internet Explorer. In some embodiments, a user may download and display the trace data using a SAPGUI. Optionally, a user at any of these devices may, for example, delete trace data from database via trace interface.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for collecting application trace data in a heterogeneous computer system comprising at least one server and at least one remote computer system, the method comprising:
activating a trace function at the server in response to a request from a first remote computer system;
receiving information representing user preferences for collecting trace data for debugging an application communicating between the server and a second remote computer system;
collecting, with the trace function, trace data related to execution of the application based on the user preference information; and
storing the collected trace data at the server in a standard format for web browsers.

2. The method of claim 1, wherein the first and second remote computer systems are the same system.

3. The method of claim 1, further comprising:
converting the collected trace data to the standard format for web browsers prior to storing.

4. The method of claim 1, wherein the received user preference information includes storage information indicating whether to stored the trace data to a database at the server or to a memory buffer.

5. The method of claim 4, further comprising:
storing the collected trace data at the server in a memory buffer, if the user indicates a preference for storing in the memory buffer and
committing the trace data in the memory buffer to the database;
otherwise, storing the collected trace data at the server to a database.

6. The method of claim 1, wherein the user preferences are received from a second computer system different than the remote computer system.

7. The method of claim 1, wherein the user preferences include at least one of a start date, a start time, a trace period, an initial system, an initial user, an initial action, a type of information, a type of application, and whether the trace for at least one of the applications is activated or deactivated.

8. The method of claim 1, wherein at least one of the first or second remote computer systems is a non-SAP system.

9. A system comprising:
a processor; and
a first memory, wherein the processor and the memory are configured to perform a method comprising:
activating a trace function at the server in response to a request from a first remote computer system,
receiving information representing user preferences for collecting trace data for debugging an application communicating between the server and the remote computer system,
collecting, via the trace function, trace data related to execution of the application based on the user preference information, and
a second memory for storing the collected trace data in a standard format for web browsers.

10. The system of claim 9, wherein the data storage device is a database or a memory buffer.

11. The system of claim 10, wherein the received user preference information includes storage information indicating whether to stored the trace data to a database at the server or to a memory buffer.

12. The system of claim 9, wherein the user preferences include at least one of a start date, a start time, a trace period, an initial system, an initial user, an initial action, a type of information, a type of application, and whether the trace for at least one of the applications is activated or deactivated.

13. An apparatus comprising:
means for receiving at the server information representing user preferences for collecting trace data for debugging an application communicating between the server and the remote computer system;
means for collecting trace data related to execution of the application based on the user preference information; and
means for storing the collected trace data at the server in a standard format for web browsers.
